(19) United States
(12) Patent Application Publication
(10) Pub. No.: US 2017/0306657 A1
(43) Pub. Date: Oct. 26, 2017

(54) SEAL FOR SECURING GOODS

(71) Applicant: Alexander Schneider, Delbrück (DE)

(72) Inventor: Alexander Schneider, Delbrück (DE)

(21) Appl. No.: 15/517,686

(22) PCT Filed: Oct. 6, 2015
(86) PCT No.: PCT/EP2015/072999

§ 371 Date: Apr. 7, 2017

(30) Foreign Application Priority Data
Oct. 8, 2014 (DE) 10 2014 014 913.7

(51) Int. Cl. E05B 73/00; E05B 47/00

(52) U.S. Cl. CPC E05B 73/0017; E05B 47/00

(57) ABSTRACT

The present invention relates to a seal for securing goods and to a method for securing an article of merchandise.

### BACKGROUND

The present invention relates to a seal for securing goods and to a method for securing a goods item. The seal according to the invention and the method according to the invention are to be used, in particular, for protection against return fraud in the case of goods that have been ordered by telephone or over the Internet.

Security tags were introduced in German department stores in the mid-1980s to prevent shoplifting. These generally consist of a transponder at the exit from the building and a transmitter coil, which is fastened to the goods item. To remove the transmitter coil from the goods item, special devices, which, for example, magnetically release the tag from the goods item, are required at the cash desk. Typically, a transmitter and a receiver are located within a defined protection zone in an EAS (electronic article surveillance) protection system of this type.

Transponder systems for detection are generally located between the shop cash desk and the store exit. There are currently four different electronic goods security systems on the market: radio frequency, electromagnetic, high frequency and acousto-magnetic goods security systems, each with different EAS elements. Depending on the type of security, the tag located on the goods item can be recognised by measurable magnetic fields, resonance frequencies and/or vibrations. In the event of theft, a protected article leaves the protection zone and the EAS element triggers an alarm close to the transponders.

Alternatively, there are housings, which make the goods unusable, for example with dye, upon unauthorised removal of the goods item. Common to all the previous goods security tags is the exclusively passive function, i.e. they can only be activated and deactivated by cashiers with the aid of special tools.

In the case of distance selling, i.e. when ordering by telephone or over the Internet and sending the ordered goods item by post or delivery service, no goods security systems have thus far been used. However, distance selling suffers in particular from the growing phenomenon of so-called “wardrobing”. In the case of distance contracts, the consumer in Germany basically has a cancellation right. In other words, the consumer can cancel a sales contract agreed, for example, over the Internet, without giving reasons within a deadline of two weeks and return the goods item already received. Huge use is in part made of this cancellation right. Thus, for example, between 30% and 50% of the goods in the clothing and shoe sectors are returned.

As long as this cancellation right is only utilised to inspect and, if necessary, try on the goods item received, this does not present further problems. In fact, however, the goods are often ordered with fraudulent intent and not at all for the purpose of a purchase, but are merely “borrowed” from the retailer. In other words, for example, a specific item of clothing or a pair of shoes is ordered for a specific occasion or is worn for a week and then returned having regard for the cancellation right. Because of the resulting traces of use, in certain sectors 10% of the goods items returned cannot be resold.

In order to take this growing problem into account, the object of the present invention is to provide a seal or a method for securing goods that can effectively prevent wardrobing.

Conventional goods security tags are not suitable for this because inter alia they can only be removed by the retailer with the aid of special devices in the shop or department store and do not permit any customer interaction, such as the provision of goods information or opening by the customer.

### BRIEF DESCRIPTION

The invention is based inter alia on the idea of providing a seal or a goods security tag, which can only be released from the secured goods item when a data input unit and/or data receiving unit of the seal or the goods security tag receives a predetermined data signal, which the retailer only provides when the customer has waived his cancellation right, the two-week deadline has expired or the customer has paid for the goods item in stationary trading. For this, the seal is attached to a prominent location on the goods item (for example on the front of an item of clothing) so the goods item can only be used to a limited extent. For example, most fraudsters would probably shy away from wearing an item of clothing provided with a seal of this type, publicly or for a specific occasion. Nevertheless, the seal allows unlimited checking of the clothing, so the cancellation right is satisfied. Once the customer has adequately tested the goods item and is sure that he would like to buy and keep the item, he informs the retailer accordingly. The retailer then provides a code or a data signal, which the customer inputs into the data input unit of the seal or which is directly received by the data receiving unit of the seal. The seal can then be removed from the goods item without damage and the goods item can be utilised fully.

However, the present invention is not limited to distance selling, but also allows use in stationary trading, in order, for example, to accelerate the buying process, to provide goods information and to improve the shopping experience. Digitisation of trade has hitherto failed thanks to corresponding concepts of added value for customers. Growth in stationary trading is also stagnating, while distance selling is growing annually. The present invention is intended to solve this discrepancy.

Thus, the goods item can alternatively be presented in the retailer's shop and paid for by mobile or online payment by the customer. The seal can then be removed on site once payment has been made and the theft protection is thereby cancelled. The goods item has then passed into the ownership of the customer. The seal may, for example, be released by means of the (customer's) smartphone or at a self-service terminal. An application (app), which communicates with the seal, could be installed on the smartphone. Using this software, goods information could be read out, transactions triggered and the release code forwarded. Customers without a corresponding mobile device could release the seal at special self-service terminals; in this case the terminal forwards the code. The customer can then leave the shop together with the purchased goods item. This has the advantage that the customer does not have to queue up at a conventional cash desk or does not have to occupy the sales staff. He saves time in this way. In turn, the retailer can replace cashiers with sales staff and concentrate on customer advice. Customer loyalty programmes and discount campaigns can also be connected by the personalised approach via the customer's terminal to the buying process and the seal removal. In this case, the communication between the seal and smartphone or self-service terminal preferably takes place by near field communication (NFC), i.e. according to ISO 18000-2, -3 and 22536, as this inter alia makes secure data transmission possible.

Once the seal has been removed from the goods item, it can no longer be attached to the goods item by the customer. Without a seal (or with a damaged or manipulated one), however, the retailer will no longer take the goods item back from the customer or demand compensation. Complaints or an exchange are still possible in accordance with legal conditions or individual terms and conditions. A seal fastened to the goods item continues to maintain the theft protection in stationary trading.

The invention inter alia relates to a seal for securing goods, the seal having a first portion with a connecting element, a second portion with a receiving element for receiving at least one part of the connecting element and a data input unit and/or data receiving unit. The first and second portions can be connected to one another by introducing at least one part of the connecting element into the receiving element. The first and second portions can only be separated from one another again in a non-destructive manner when the data input unit and/or data receiving unit receives a predetermined data signal. In this case, the connecting element preferably has a needle.

The term “needle” in the context of the present invention is to be taken to mean an elongate, thin tool made of hard material with a point at one end and also comprises, for example, the terms “nail” and “mandrel”. The needle is preferably configured in such a way that it can pierce the material of conventional items of clothing. In this case, the thickness of the needle is preferably selected such that no substantial visible traces are left by pulling the needle out of the material.

The two portions of the seal preferably consist of a stable, hard material, for example a hard plastics material. At least one of the two portions is preferably configured to be so large that the seal attached to the goods item visibly spoils the look of the item. The outer surface of one of the two portions preferably has an area of at least 25 cm², particularly preferably of at least 50 cm². The seal can also be correspondingly conspicuously marked by conspicuous colours and/or patterns or by a corresponding inscription (“Property of . . . ”).

A “non-destructive” separation of the two portions means a separation in such a way that no visible traces remain for the retailer. This feature is merely to ensure that the retailer can determine from the returned goods item and the seal fastened thereon whether the seal has previously been removed. In stationary trading, a removed seal indicates a purchase and to prove this purchase, till/purchase receipts are additionally possible in physical or electronic form. A seal that has not been removed triggers the described anti-theft alarm when the monitoring area is left.

The needle preferably has a pointed end and a blunt end, the pointed end being irreversibly connected to the receiving element on introduction into the receiving element. This has the advantage that the customer does not come into contact with the pointed end of the needle and a potential risk of injury can thus be effectively avoided. When the first and second portions are separated from one another by the customer, this preferably takes place by releasing the blunt end of the needle. The blunt end of the needle can preferably then and only then be separated from the first portion when the data input unit and/or data receiving unit receives the predetermined data signal. The first portion of the seal preferably has a security mechanism, which fixes the blunt end of the needle in the first portion and is suitable for releasing the blunt end of the needle when the data input unit and/or data receiving unit receives the predetermined data signal. For this purpose, the blunt end of the needle preferably has an opening and/or groove, which engages with a bolt and/or projection of the security mechanism. Alternatively, a clip, clamp or spring can fix the needle, as described, for example, in U.S. Pat. No. 5,426,419 A. When the goods item is sent to the customer together with the seal, a bolt of the security mechanism, for example, can be introduced into an opening in the blunt end of the needle in such a way that the needle cannot be removed from the first portion of the seal. As soon as the data input unit and/or data receiving unit receives the predetermined data signal, the bolt is either actively pulled back or else released, so it can, for example, be manually pulled back by the customer. The needle, which can then be released from the first portion of the seal together with the second portion of the seal, is thereby in turn released. The pointed end of the needle remains in the second portion of the seal in this case.

The pointed end of the needle preferably has a groove, which irreversibly latches with a latching mechanism of the receiving element on introduction of the needle into the receiving element.

If the seal according to the invention is to be used in stationary trading for theft protection, the seal preferably has an EAS element. An EAS element of this type may, for example, have an acoustically resonant magnet element, as described, for example, in U.S. Pat. No. 4,510,489 and U.S. Pat. No. 4,510,490. The elements described in U.S. Pat. No. 4,686,516 and U.S. Pat. No. 4,797,658 can also be used according to the invention as EAS elements.

The preferred embodiment of the seal according to the invention described here, in which the connecting element has a needle, can be particularly advantageously used for securing items of clothing, shoes and other goods, which can be easily pierced by a needle, at least in portions (such as, for example, leather bags, carpets, curtains and the like). As the problem of wardrobing or theft is not, however, limited to these goods, but also occurs, for example, in the sector of accessories such as gloves, sunglasses and the like, the present invention is not limited to seals with connecting elements having a needle. Rather, the connecting element may also have a bolt, a pin, a cable, a wire, a rope or a bracket.

The present invention furthermore relates to a method for securing a goods item. A seal and a goods item are firstly provided. The seal has a first portion with a connecting element, a second portion with a receiving element for receiving at least one part of the connecting element and a data input unit and/or data receiving unit. The seal is preferably a seal as described above. The first and second portions of the seal are connected to one another by introducing at least one part of the connecting element into the receiving element in such a way that the seal is connected to the goods item and cannot be removed again from the item without the first and second portions of the seal being separated from one another. In this case, the first and second portions should only be able to be separated from one another again in a non-destructive manner when the data input unit and/or data receiving unit receives a predetermined data signal. The goods item with the seal fastened thereon is then forwarded to a customer, for example sent to him by post or delivery service or the customer collects the item at a branch of the retailer. Once the customer has finally decided to keep the goods item and to pay for it and would like to waive the cancellation right (or else after two weeks have passed), the predetermined data signal is transmitted to the data input unit and/or data receiving unit. The first and second portions of the seal may then be separated from one another in order to release the goods item.

Alternatively, the goods item is on display in the retailer's shop. The customer can test and try the goods item here as customary. As soon as the customer has decided to buy the goods item and pay for it (for example by mobile payment using a smartphone or by e-payment using an Internet connection, at a self-service cash desk terminal or traditional cash desk terminal by conventional payment methods), the predetermined data signal is transmitted to the data input unit and/or data receiving unit. The first and second portions of the seal can then be separated from one another to release the goods item. In this case, no anti-theft alarm is triggered on leaving the monitoring region.

Common to the two alternatives inter alia is the opening of the security mechanism directly by the end customer. Previous solutions always require trained staff for this and special opening systems, which are generally installed stationarily at the point of sale, and this does not allow the flexible use that the invention provides.

The two seal portions can be released from one another, for example in that the predetermined data signal is firstly forwarded (for example on request) to the customer and he then inputs the data signal received into the data input unit. Alternatively, the predetermined data signal can also be transmitted directly by the retailer to the data receiving unit, for example via the Internet.

The connecting element preferably has a needle. The connection of the first and second portions of the seal in such a way that the seal is connected to the goods item then preferably comprises the piercing of a portion of the goods item with the aid of the needle so that this portion of the goods item is fixed between the first and second portions of the seal. The first and second portions of the seal are preferably additionally connected to one another via a cable, a wire or a bracket, so the goods item does not have to be fixed by piercing with a needle, but, for example, in that the cable, the wire or the bracket is looped around a portion of the goods item, for example a handbag handle, and the item is thus connected to the seal.

Preferred embodiments of the present invention will be described in more detail by means of the following aspects:

1. Seal for securing goods, wherein the seal has a first portion with a connecting element, a second portion with a receiving element for receiving at least one part of the connecting element and a data input unit and/or data receiving unit, wherein the first and second portions can be connected to one another by introducing at least one part of the connecting element into the receiving element, and wherein the first and second portions can only be separated from one another again in a non-destructive manner when the data input unit and/or data receiving unit receives a predetermined data signal.

2. Seal according to aspect 1, wherein the connecting element has a needle.

3. Seal according to aspect 2, wherein the needle has a pointed end and a blunt end and wherein the pointed end is irreversibly connected to the receiving element on introduction into the receiving element.

4. Seal according to aspect 3, wherein the blunt end of the needle can be separated from the first portion when the data input unit and/or data receiving unit receives the predetermined data signal.

5. Seal according to aspect 3 or 4, wherein the first portion has a security mechanism, which fixes the blunt end of the needle in the first portion and is suitable for releasing the blunt end of the needle when the data input unit and/or data receiving unit receives the predetermined data signal.

6. Seal according to aspect 5, wherein the blunt end of the needle has an opening and/or groove and wherein the security mechanism has one or a combination of the following elements, which engage(s) with the opening and/or groove: bolt, projection, clip, clamp, spring.

7. Seal according to any of aspects 2 to 6, wherein the pointed end of the needle has a groove, which, on introduction of the needle into the receiving element, permanently, preferably irreversibly, latches with a latching mechanism of the receiving element.

8. Seal according to any of the previous aspects, wherein the connecting element has one or a combination of the following elements: needle, bolt, pin, cable, wire, rope, bracket.

9. Seal according to aspect 8, wherein one end of the connecting element has a first engagement element, which is suitable, on introduction into the receiving element, for engaging permanently, preferably irreversibly, with the receiving element, for example by gluing, or preferably for latching with the aid of a magnetic connection.

10. Seal according to aspect 9, wherein the first engagement element has one or a combination of the following elements: groove, recess, opening, bore, eyelet, wedge, spring, hook, projection, flutes, corrugations, notches.

11. Seal according to aspect 9 or 10, wherein the receiving element has a second engagement element, which is suitable, on introduction of the connecting element into the receiving element, for engaging permanently, preferably irreversibly, with the first engagement element, for example by gluing, or preferably for latching with the aid of a magnetic connection.

12. Seal according to aspect 11, wherein the second engagement element has one or a combination of the following elements: groove, recess, opening, bore, eyelet, wedge, spring, hook, projection, flutes, corrugations, notches.

13. Seal according to any of aspects 8 to 12, wherein the connecting element has a first end and a second end, and wherein the first end, on introduction into the receiving element, is irreversibly connected to the receiving element.

14. Seal according to aspect 13, wherein the second end can be separated from the first portion when the data input unit and/or data receiving unit receives the predetermined data signal.

15. Seal according to aspect 13 or 14, wherein the first portion has a security mechanism, which fixes the second end in the first portion and is suitable for releasing the second end when the data input unit and/or data receiving unit receives the predetermined data signal.

16. Seal according to any of aspects 13 to 15, wherein the second end of the connecting element has one or a combination of the following elements: groove, recess, opening, bore, eyelet, wedge, spring, hook, projection, flutes, corrugations, notches.

17. Seal according to any of aspects 15 to 16, wherein the security mechanism has one or a combination of the following elements: groove, recess, opening, bore, eyelet, wedge, spring, hook, projection, flutes, corrugations, notches.

18. Seal according to any of aspects 15 to 17, wherein the security mechanism has a motor or drive, which is suitable for releasing the second end when the data input unit and/or data receiving unit receives the predetermined data signal.

19. Seal according to any of the previous aspects, wherein the first portion furthermore has: a microprocessor and/or a battery and/or an on/off switch.

20. Seal according to any of the previous aspects, wherein the data input unit and/or data receiving unit has one or a combination of the following elements: phototransistor, photodiode, barcode reading unit, QR-code reading unit, keyboard, touchpad, serial data interface such as, for example, USB or Firewire, camera, number combination lock, RFID, NFC, SIM, Bluetooth.

21. Seal according to any of the previous aspects, wherein the first portion furthermore has an EAS element.

22. Method for securing a goods item, having the following steps:

(a) providing a seal having a first portion with a connecting element, a second portion with a receiving element for receiving at least one part of the connecting element and a data input unit and/or data receiving unit, preferably a seal according to any of the preceding aspects;

(b) providing a goods item;

(c) connecting the first and second portions of the seal by introducing at least one part of the connecting element into the receiving element in such a way that the seal is connected to the goods item, wherein the first and second portions can only be separated from one another again in a non-destructive manner when the data input unit and/or data receiving unit receives a predetermined data signal;

(d) forwarding or providing, in particular sending or presenting, the goods item together with the seal to a customer;

(e) forwarding the predetermined data signal to the data input unit and/or data receiving unit; and

(f) separating the first and second portions from one another to release the goods item.

23. Method according to aspect 22, wherein the step of forwarding the predetermined data signal to the data input unit and/or data receiving unit has the following steps: forwarding the predetermined signal to the customer and inputting the forwarded data signal into the data input unit.

24. Method according to aspect 22 or 23, wherein the step of forwarding the predetermined data signal to the data input unit and/or data receiving unit takes place and/or is authorised by an external apparatus, as soon as a payment has been made, preferably by mobile or e-payment.

25. Method according to aspect 23, wherein the step of inputting the forwarded data signal into the data input unit has one or a combination of the following steps: inputting a code into a keyboard or a mechanical combination lock, reading in a barcode or QR-code with the aid of a barcode reading unit or QR-code reading unit, a scanner or a camera, generating or processing an optical or acoustic signal, forwarding the data signal via a serial data interface, reading out, deciphering and/or decoding the forwarded data signal.

26. Method according to aspect 22, wherein the step of forwarding the predetermined data signal to the data input unit and/or data receiving unit has the following steps: transmitting directly or indirectly the predetermined data signal to the data receiving unit.

27. Method according to any of aspects 22 to 26, wherein the forwarding of the predetermined data signal to the customer or the transmission of the predetermined data signal to the data receiving unit takes place via an Internet or mobile radio connection.

28. Method according to any of aspects 22 to 27, wherein the step of forwarding the predetermined data signal to the data input unit and/or data receiving unit takes place using a mechanism for producing a flicker code.

29. Method according to any of aspects 22 to 28, wherein the first and second portions of the seal are additionally connected to one another via a cable, a wire, a rope or a bracket.

30. Method according to any of aspects 22 to 29, wherein the connecting element has a needle and wherein step c) comprises the piercing of a portion of the goods item so that this portion of the goods item is fixed between the first and second portions of the seal.

### BRIEF DESCRIPTION OF THE DRAWINGS

Particularly preferred embodiments of the present invention will be described in more detail below with reference to the drawings, in which:

FIG. 1a is a plan view of a first portion of a preferred embodiment of the seal according to the invention;

FIG. 1b is a side view of the first portion according to FIG. 1a;

FIG. 2 is a lateral sectional view of the first portion of FIG. 1a;

FIG. 3 is a schematic view of electronic components of the seal according to the invention;

FIGS. 4a to 4g show preferred features of the connecting element according to the invention;

FIG. 5 is a lateral sectional view of the second portion of a preferred embodiment of the seal according to the invention;

FIG. 6 is a lateral part sectional view of a preferred embodiment of a seal according to the invention;

FIG. 7 is a perspective view of the seal according to FIG. 6;

FIG. 8a shows a first portion of a seal according to a further preferred embodiment;

FIG. 8b is a side view of the first portion according to FIG. 8a;

FIG. 9a is a plan view of a first portion of a seal according to a further preferred embodiment;

FIG. 9b is a side view of the first portion according to FIG. 9a;

FIG. 10a is a plan view of a first portion of a seal according to a further preferred embodiment;

FIG. 10b is a side view of the first portion according to FIG. 10a; and

FIG. 11 shows a seal according to a further preferred embodiment.

### DETAILED DESCRIPTION

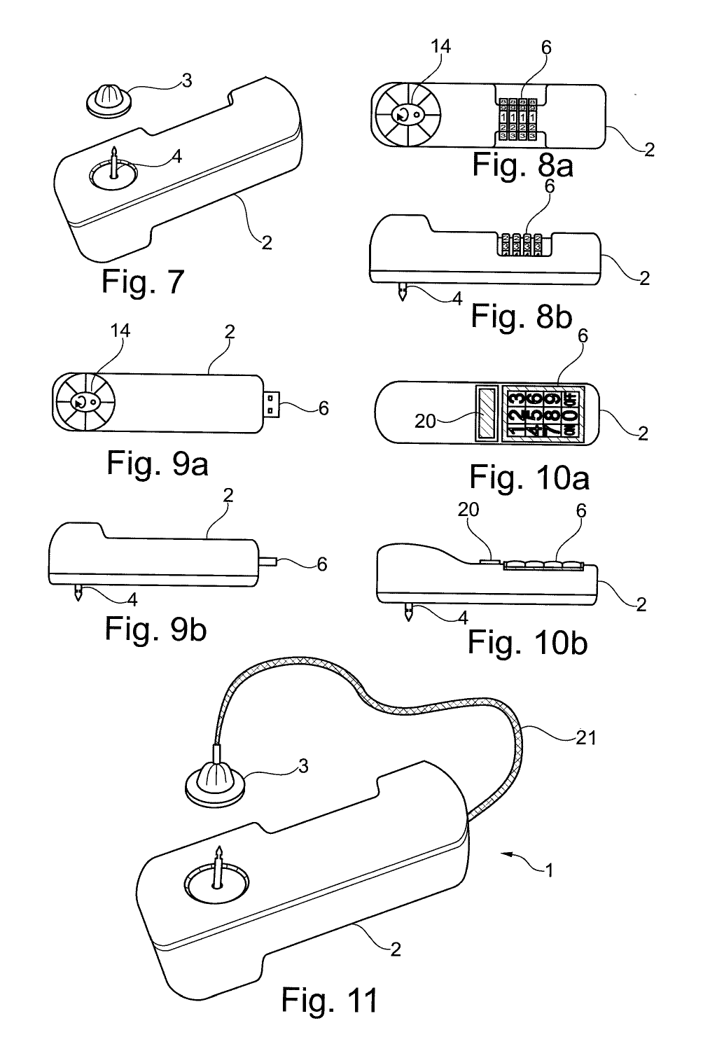

FIGS. 6 and 7 are a lateral part sectional view and a perspective view of a preferred embodiment of the seal 1 according to the invention for securing a goods item 19. The seal 1 has a first portion 2 with a connecting element 4 and a second portion 3 with a receiving element 5 for receiving at least one part of the connecting element 4. The first portion 2 and the second portion 3 can be connected to one another by introducing at least one part of the connecting element 4 into the receiving element 5 in such a way that the seal 1 is connected to the goods item 19. A portion of the goods item 19 is pierced here by the connecting element 4 so that said portion of the goods item 19 is fixed between the first portion 2 and the second portion 3 of the seal 1.

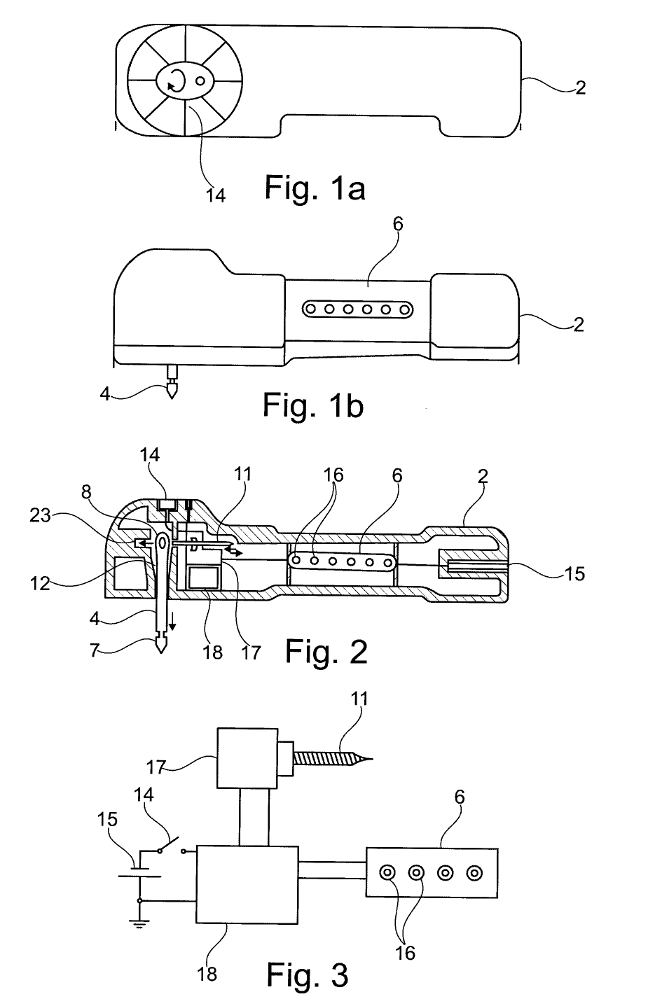

FIG. 5 is a detailed sectional view of the second portion 3 of the seal according to FIGS. 6 and 7. In the preferred embodiment shown here, the connecting element 4 has a needle with a pointed end 7, which can be received by the receiving element 5 of the second portion 3. In this case, a groove 12 in the pointed end of the needle 4 latches irreversibly with a latching mechanism 13 of the receiving element 5. The latching mechanism 13 may, for example, be formed by a clip or spring, which, on introduction of the needle 4 into the receiving element 5, slides over the pointed end 2 of the needle and then latches with the groove 12 of the needle. It is now no longer possible to pull back the needle 4 from the receiving element 5. The first portion of the seal 1 and the second portion 3 of the seal 1 are connected to one another in this manner via the needle or the connecting element 4 and can only be separated from one another again in a non-destructive manner when the data input unit or data receiving unit 6 receives a predetermined data signal. An embodiment of a corresponding release mechanism is shown in the sectional view according to FIG. 2. The first portion 2 of a seal 1 depicted there can also be seen in a plan view and side view in FIGS. 1a and 1b.

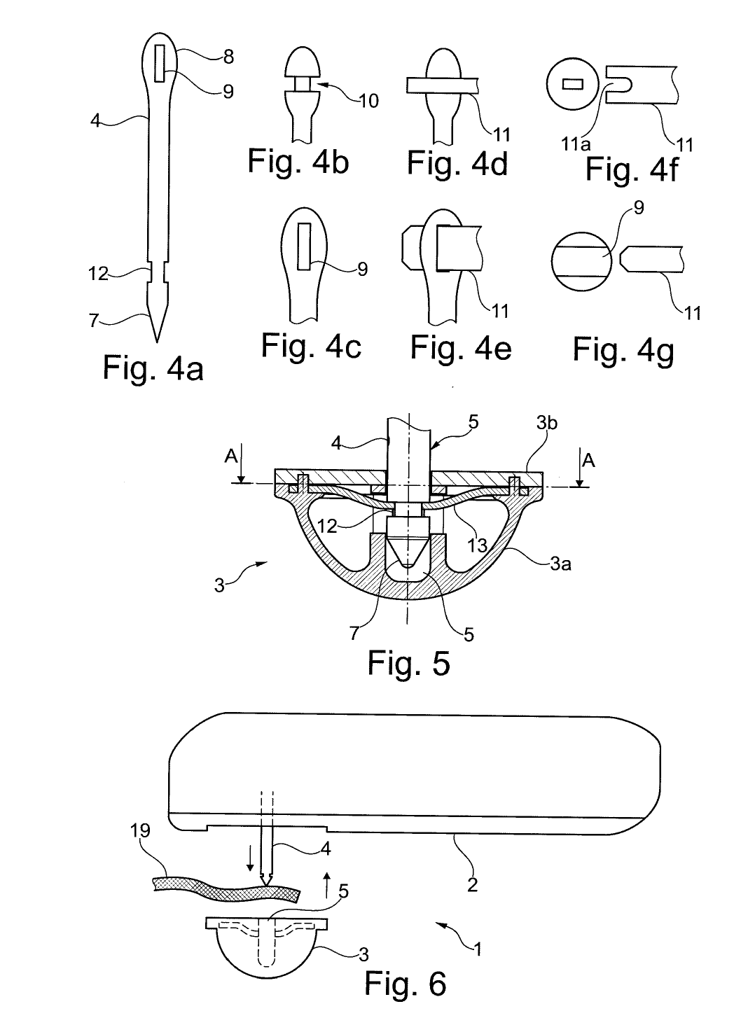

The first portion 2 of the seal has a cavity or an opening 22, into which the blunt end 8 of a needle 4 (cf. also FIG. 4a) can be received. As shown in detail in FIG. 4a, the needle 4 may have an opening or a slot 9 at its blunt end 8. The security mechanism 17 of the first portion 2 of the seal has a bolt or pin 11, which can be moved to the left and right by means of a motor of the security mechanism 17 in such a way that the bolt 11 engages with the opening 9 in the needle 4. If the bolt 11 is moved from the position shown in FIG. 2 with the aid of the motor to the left through the opening 9 in the needle 4 until the left-hand end of the bolt 11 is received in the groove 23, the needle 4 is secured against being pulled out of the opening 22. In other words, the blunt end 8 of the needle 4 is fixed in the first portion 2 of the seal 1. As at the same time, as described above, the pointed end 7 of the needle 4 irreversibly latches with the latching mechanism 13 of the receiving element 5 of the second portion 3 of the seal 1; the seal cannot be removed from the goods item 19 without damaging either the seal or the goods item. Moreover, a detectable EAS element may be located in the seal if this seal is to be used in stationary trading. This is preferably an acousto-magnetic element with a plurality of magnetically hard metal strips.

When the data input unit or data receiving unit 6 now receives a predetermined data signal, with the aid of the motor of the security mechanism 17, the bolt 11 is pulled out of the groove 23 and the opening 9 in the needle and is moved into the position shown in FIG. 2. Alternatively, the needle can be indirectly released, for example in that a clip, clamp or spring, which is latched to the needle, is released by a mechanical movement, for example by the bolt, a motor or magnet. The blunt end 8 of the needle 4 is now released and the needle 4 can be pulled out of the opening 22 in the first portion 2 of the seal substantially without resistance. In this case, the pointed end 7 of the needle 4 remains in the receiving element 5 of the second portion 3, so the blunt end 8 of the needle 4 has to be pulled through the goods item 19 to release it.

The security mechanism 17 or the motor thereof for moving the pin or bolt 11 is controlled by a microprocessor 18 and supplied with power by a current supply 15, for example a battery. The electronic components are shown schematically in FIG. 3. In order to spare the battery 15, an on/off switch 14 may be provided, which has to be actuated by the customer before the predetermined data signal is input into the data input unit 6 or transmitted to the data receiving unit 6. In the preferred embodiment shown, the data receiving unit 6 has a plurality of phototransistors or photodiodes 16, which are suitable for receiving an optical signal. One such may, for example, be provided, as in online banking, on a monitor or display, shown by means of a plurality of flickering black/white areas. With the aid of the flickering, data, such as, for example, the code for moving the bolt 11, can be transmitted to the photodiodes or phototransistors 16 of the data receiving unit 6 and are then processed further and/or deciphered in the microprocessor 18 to then optionally set the bolt 11 in motion. Instead of this technology, data transmission by means of NFC or Bluetooth Low Energy (BLE) may also be used, for example.

Obviously, the present invention is neither limited to the data receiving unit 6 shown in FIG. 2 nor to the special security mechanism 17. In particular, instead of the motor, which moves the bolt 11, a magnetic mechanism or the like may also be used. In a particularly simple embodiment, the bolt is metallic and is moved with the aid of a coil by applying current. An indirect movement is also conceivable, for example in that a latched-in clip, clamp or spring is released and the latter then releases the needle 4. Instead of a data receiving unit 6 with phototransistors 16, a data receiving unit 6 with a serial data interface can also be used, such as, for example, a USB connection, as shown schematically in FIGS. 9a and 9b. Instead of a data receiving unit, a data input unit can also be provided, into which the customer has to actively input a number code, for example. This data input unit 6 may, for example, have a keyboard (cf. FIGS. 10a and 10b) or a mechanical combination lock (cf. FIGS. 8a and 8b). In addition, a display 20 (cf. FIGS. 10a and 10b) may be present to display information.

The needle 4 of the preferred embodiment of FIG. 2 is depicted again in detail in FIG. 4a. The opening 9 in the blunt end 8 of the needle 4 can, as shown in FIGS. 4a and 4c, be an elongate slot. A correspondingly shaped bolt or pin 11 can be introduced therein, as sketched in a perspective side view and plan view in FIGS. 4e and 4g. Obviously, the opening 9 may also have a different shape and, in particular, be square, round, elliptical or triangular. The cross section of the bolt or pin 11 is preferably adapted in this case to the cross section of the opening 9. Instead of an opening 9, the blunt end 8 of the needle 4 may also, for example, have a groove 10, as shown in FIG. 4b. The bolt or pin 11 then preferably has a notching or opening 11a, which can engage with the groove 10, as shown schematically in a side view and plan view in FIGS. 4d and 4f.

It is obvious that the seal according to the invention can also differ with respect to further features from the preferred embodiments shown here. In particular, the first and second portions of the seal may have a different shape and size. Furthermore, the first portion 2 and the second portion 3 of the seal 1 may additionally be connected to one another via, for example, a cable 21, as indicated in FIG. 11. Instead of the cable, a wire or a bracket may also be used. This embodiment is particularly suitable for protecting goods other than items of clothing, such as, for example, handbags, sunglasses or other accessories from wardrobing. For this, the second portion 3 is guided together with the cable 21, for example through the handle of a handbag and is connected to the first portion 2 of the seal 1 with the aid of the needle 4. As a result, the seal 1 is fixed to the handbag and can, as was described above, only be released again therefrom after receipt of the predetermined data signal.

With the invention, it is possible to provide a security tag or a seal, which allows the customer independently to free the goods item previously bought or paid for therefrom and to thus prevent an exchange fraud or to accelerate the checkout process in stationary trading.

The housing of the security tag, i.e. the first and second portions, is preferably manufactured from stable plastics material. The first portion preferably has a two-part structure and contains a closure, which, with a mechanical or magnetic lock, firmly holds the needle head or the blunt end of the needle in the second portion or housing upper part and is preferably manufactured from metal. The closure has the task of temporarily holding the needle, for example by means of a bolt, which engages in a needle eye or a notch in the needle and thus securely locks it in the upper part. The closure is preferably moved by an (electro)mechanical drive. After unlocking, the needle can be removed and the starting position cannot be reproduced by the customer. The tag or the seal can only be returned by the retailer to the delivery state with a new needle.

This lock is opened by an individual data input, for example a code. The technology for data input or for data reception (release technology) is located for this purpose in the first portion. This may be electronic, digital, for example by means of RFID, Bluetooth or NFC chip or a SIM card. The code is received here by means of corresponding transmission technology. Likewise, it may take place by means of an optical component, such as a laser, a camera, a photodiode or infrared diode. The optical component reads the code here by means of data acquisition. Or, it may be an external plug connection such as USB. The code is transmitted here by means of special software. Alternatively, the data input may take place magnetically or mechanically, for example via a combination lock, a key or a rotary combination. The code is input mechanically here. Direct data input of the code by means of an integrated keyboard with a display is likewise possible.

The central idea of every form of data input is the clear identification of the security tag or seal and the goods item connected thereto for subsequent release of the closure. This is to prevent a plurality of similar goods articles from being able to be unlocked with the same code. It is also thus possible using corresponding software to read out product-specific information and to provide this to the customer.

With the exception of the magnetic or mechanical data input and the external plug connection to software, the technology furthermore preferably has its own current supply. This may, for example, be ensured by a replaceable battery. In order to spare the battery voltage when not in use, it is advisable to equip the security tag with a power switch. Furthermore, the internal data processing and control of the closure mechanism is preferably ensured by a microprocessor.

Each security tag has a serial number allocated to it. A code is advantageously produced from the article number of the goods item to be protected and the serial number of the security tag. Only this code opens the closure. The code can be permanently stored in the microprocessor or be stored on the apparatus at each new goods attachment by means of the release technology.

The needle, the needle head of which is temporarily fastened by the eyelet in the closure, can be introduced by the needle tip into the housing lower part, where it is irreversibly mechanically or magnetically clamped in or alternatively is permanently glued. For this purpose, the needle preferably has a smooth, notched or corrugated surface, which, in interaction with a clip or rupture disc fastened in the lower part undergoes a permanent connection. Instead of a needle, a (wire) rope or a (wire) loop with the same fastening, which does not perforate the goods item but runs through potential openings in the item, is also conceivable. This rope could additionally also be rigidly connected to the upper and lower part (or first and second portion). A further alternative is two magnets, one in each case in the upper and the lower part, wherein the magnet in the upper part or first portion can be deactivated or have the polarity reversed by the code and thus cancel the connection. In this case, the goods item in the closed state is clamped in between the magnets of the housing and protected until the closure is opened.

The lower part or the second portion preferably has a two-part structure and has the task of permanently gripping the needle to thus protect the end customer from injuries from the needle tip and also, in connection with the upper part, to be fastened to the goods item, securely and permanently until it is opened. The needle can also be held within the lower part by a clip, a rupture disc or a magnet. Alternatively, an adhesive connection can ensure the desired fastening.

In the state attached to the goods item, in the ideal application, the lower part is concealed and the upper part is visibly fastened to the goods item.

Furthermore, the upper part can be equipped with a new needle and thus repeatedly reused, while the needle connected to the lower part can only be removed by destruction and thus the lower part cannot be reused. Alternatively, the lower part can be constructed in such a way that the needle can be removed and thus reused.

1. Seal for securing goods, wherein the seal has a first portion with a connecting element, a second portion with a receiving element for receiving at least one part of the connecting element and a data input unit and/or data receiving unit, wherein the first and second portions are connectable to one another by introducing at least one part of the connecting element into the receiving element, wherein the first and second portions are only separable from one another again in a non-destructive manner when the data input unit and/or data receiving unit receives a predetermined data signal, and wherein the connecting element has a needle.

2. Seal according to claim 1, wherein the needle has a pointed end and a blunt end and wherein the pointed end, on introduction into the receiving element, is irreversibly connected to the receiving element.

3. Seal according to claim 2, wherein the blunt end of the needle can be separated from the first portion when the data input unit and/or data receiving unit receives the predetermined data signal.

4. Seal according to claim 2, wherein the first portion has a security mechanism, which fixes the blunt end of the needle in the first portion and which is suitable for releasing the blunt end of the needle when the data input unit and/or data receiving unit receives the predetermined data signal.

5. Seal according to claim 4, wherein the blunt end of the needle has an opening and/or groove and wherein the security mechanism has a bolt and/or projection, which engages with the opening and/or groove.

6. Seal according to claim 2, wherein the pointed end of the needle has a groove, which, on introduction of the needle into the receiving element, irreversibly latches with a latching mechanism of the receiving element.

7. Seal according to claim 1, wherein the first portion has an EAS element.

8. Method for securing a goods item, having the following steps:
(a) providing a seal with a first portion with a connecting element, a second portion with a receiving element for receiving at least one part of the connecting element and a data input unit and/or data receiving unit;
(b) providing a goods item;
(c) connecting the first and second portions of the seal by introducing at least one part of the connecting element into the receiving element in such a way that the seal is connected to the goods item, wherein the first and second portions are only separable from one another again in a non-destructive manner when the data input unit and/or data receiving unit receives a predetermined data signal;
(d) forwarding or providing the goods item together with the seal to a customer;
(e) transmitting the predetermined data signal to the data input unit and/or data receiving unit; and
(f) separating the first and second portions from one another to release the goods item.

9. Method according to claim 8, wherein the step of transmitting the predetermined data signal to the data input unit and/or data receiving unit has the following steps:
forwarding the predetermined data signal to the customer, and
inputting the forwarded data signal into the data input unit, or
transmitting the forwarded data signal to the data receiving unit.

10. Method according to claim 8, wherein the step of transmitting the predetermined data signal to the data input unit and/or data receiving unit takes place and/or is authorised by an external apparatus, as soon as a payment has been made, preferably by mobile or e-payment.

11. Method according to claim 8, wherein the step of transmitting the predetermined data signal to the data input unit and/or data receiving unit has a direct or indirect transmission of the predetermined data signal to the data receiving unit.

12. Method according to claim 8, wherein the first and second portions of the seal are additionally connected to one another via a cable, a wire or a bracket.

13. Method according to claim 8, wherein the connecting element has a needle and wherein step (c) comprises piercing a portion of the goods item, so that this portion of the goods item is fixed between the first and second portions of the seal.
